(19) United States
(12) Patent Application Publication
(10) Pub. No.: US 2025/0045860 A1
(43) Pub. Date: Feb. 6, 2025

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: Panasonic Intellectual Property Corporation of America, Torrance, CA (US)

(72) Inventor: Shinichiro Hamada, Osaka (JP)

(21) Appl. No.: 18/924,297

(22) Filed: Oct. 23, 2024

Related U.S. Application Data
(63) Continuation of application No. PCT/JP2023/015853, filed on Apr. 21, 2023.

(30) Foreign Application Priority Data
Apr. 26, 2022 (JP) 2022-072481

(51) Int. Cl. G06Q 50/47

(52) U.S. Cl. CPC G06Q 50/47; G06Q 2240/00

(57) ABSTRACT

A server acquires a boarding point and an alighting point of each of a plurality of passengers riding together in a vehicle; calculates utility enjoyed by each of the plurality of passengers for a ridesharing service based on the boarding point and the alighting point of each passenger; calculates a total ridesharing fare for transportation through a route from a point where a first passenger, among the plurality of passengers, is picked up to a point where a last passenger is dropped off; and calculates, as a fare to be charged to each passenger, an amount obtained by distributing the total ridesharing fare to the plurality of passengers in accordance with a ratio of the utility of each of the plurality of passengers.

### FIELD OF INVENTION

The present disclosure relates to a technique for calculating a fare to be charged to a plurality of passengers riding together in a vehicle.

### BACKGROUND ART

Conventionally, in order to improve transportation efficiency, a ridesharing service for transporting a plurality of passengers who ride together by one vehicle has been provided. The ridesharing service is required to fairly charge a fare to a plurality of passengers having different riding distances or riding times.

For example, Patent Literature 1 discloses a vehicle rental service management apparatus including: a receiving part which executes processing of receiving a request to use a vehicle from a first user and processing of receiving a request for sharing a ride on the vehicle from a second user; a route search part which searches for a first route to a parking space of the vehicle which is a destination of a return route of the first user and a second route to the parking space via a destination of the second user when the second user shares a ride on the vehicle; a fare calculation part which calculates a discount fare to be discounted from a vehicle fare when the second user shares a ride on the vehicle; and a notification part which presents notification information on the discount fare calculated by the fare calculation part and the presence of the second user on a terminal device of the first user.

However, in the above-described conventional technique, it is difficult to fairly charge a fare to a plurality of passengers having different riding distances or riding time, and further improvement is required.
Patent Literature 1: JP 2021-149384 A

### SUMMARY OF THE INVENTION

The present disclosure has been made in order to solve the above problem, and an object of the present disclosure is to provide a technique that enables fair charging of a fare to a plurality of passengers who ride together.

An information processing method according to the present disclosure is an information processing method by a computer, the method including: acquiring a boarding point and an alighting point of each of a plurality of passengers riding together in a vehicle; calculating utility enjoyed by each of the plurality of passengers for a ridesharing service based on the boarding point and the alighting point of each passenger; calculating a total ridesharing fare for transportation through a route from a point where a first passenger, among the plurality of passengers, is picked up to a point where a last passenger is dropped off; and calculating, as a fare to be charged to each passenger, an amount obtained by distributing the total ridesharing fare to the plurality of passengers in accordance with a ratio of the utility of each of the plurality of passengers.

According to the present disclosure, it is possible to fairly charge a fare to each of a plurality of passengers who ride together.

### BRIEF DESCRIPTION OF THE DRAWINGS

FIG. 1 is a view illustrating an overall configuration of a transportation system in a first embodiment of the present disclosure.

FIG. 2 is a block diagram illustrating a configuration of a server in the first embodiment of the present disclosure.

FIG. 3 is a first flowchart for explaining fare calculation processing of the server in the first embodiment of the present disclosure.

FIG. 4 is a second flowchart for explaining the fare calculation processing of the server in the first embodiment of the present disclosure.

FIG. 5 is a view illustrating an example of a scheduled fare presentation image displayed on a passenger terminal of each passenger in the first embodiment.

FIG. 6 is a view illustrating an example of a fixed fare presentation image displayed on a passenger terminal of an alighting passenger in the first embodiment.

FIG. 7 is a view illustrating another example of the fixed fare presentation image displayed on the passenger terminal of the alighting passenger in the first embodiment.

FIG. 8 is a block diagram illustrating a configuration of a server in a second embodiment of the present disclosure.

FIG. 9 is a first flowchart for explaining fare calculation processing of the server in the second embodiment of the present disclosure.

FIG. 10 is a second flowchart for explaining the fare calculation processing of the server in the second embodiment of the present disclosure.

FIG. 11 is a view illustrating an example of a scheduled fare presentation image displayed on a passenger terminal of each passenger in the second embodiment.

FIG. 12 is a view illustrating an example of the fixed fare presentation image displayed on a passenger terminal of a passenger who has already alighted in the second embodiment.

### DETAILED DESCRIPTION

### (Findings as Basis of the Present Disclosure)

In the above-described conventional technique, the route search part searches for a first route to a parking space of the vehicle which is a destination of a return route of the first user and a second route to the parking space via a destination of the second user when the second user rides together in the vehicle. The route search part calculates a difference in distance between the first route and the second route, and a ridesharing time in which the second user rides together in the vehicle on the second route. The fare calculation part calculates a discount fare to be discounted from a vehicle fare when the second user rides together in the vehicle. At this time, the fare calculation part calculates a discount fare based on the difference in distance and the ridesharing time calculated by the route search part. The notification part presents notification information on the discount fare calculated by the fare calculation part and the presence of the second user on a terminal device of the first user.

In the conventional technique, when a user has a plurality of ridesharing partners riding together in a rented vehicle, a discount fare to be discounted from the fare of the user is calculated. However, the conventional technique does not disclose that a plurality of ridesharing partners bear a discount fare, and does not consider charging a fare fairly to the plurality of ridesharing partners.

In order to solve the above problem, a technique below is disclosed.

(1) An information processing method according to one aspect of the present disclosure is an information processing method by a computer, the method including: acquiring a boarding point and an alighting point of each of a plurality of passengers riding together in a vehicle; calculating utility enjoyed by each of the plurality of passengers for a ridesharing service based on the boarding point and the alighting point of each passenger; calculating a total ridesharing fare for transportation through a route from a point where a first passenger, among the plurality of passengers, is picked up to a point where a last passenger is dropped off; and calculating, as a fare to be charged to each passenger, an amount obtained by distributing the total ridesharing fare to the plurality of passengers in accordance with a ratio of the utility of each of the plurality of passengers.

According to this configuration, the utility enjoyed by each of the plurality of passengers for a ridesharing service is calculated based on the boarding point and the alighting point of each passenger, and as a fare to be charged to each passenger, the amount obtained by distributing the total ridesharing fare to the plurality of passengers is calculated in accordance with a ratio of the utility of each of the plurality of passengers. Therefore, since the fare of each passenger is calculated in consideration of the utility enjoyed by each of the plurality of passengers for the ridesharing service, it is possible to charge the fare fairly to each of the plurality of passengers who ride together.

(2) In the information processing method according to (1), the utility may indicate a satisfaction level of each of the plurality of passengers with the ridesharing service.

According to this configuration, since the satisfaction level of each of the plurality of passengers with the ridesharing service can be reflected in the fare to be charged to each passenger, it is possible to charge the fare fairly to each of the plurality of passengers who ride together.

(3) In the information processing method according to (2), the utility may be a value that increases as a time for riding together with another passenger decreases, and that decreases as the time for riding together with another passenger increases.

According to this configuration, since the time during which the passenger rides together with another passenger can be reflected in the fare to be charged to each passenger, it is possible to charge the fare fairly to each of the plurality of passengers who ride together.

(4) In the information processing method according to (2) or (3), the utility may be calculated based on individual utility obtained by any of a fare to be charged to a passenger when the passenger is transported individually, a travel distance by which the vehicle travels when the passenger is transported individually, and a travel time required for the vehicle to travel when the passenger is transported individually, and a burden share for ridesharing obtained by a riding time in which the passenger is on board on a route from a point where a first passenger, among the plurality of passengers, is picked up to a point where a last passenger is dropped off.

According to this configuration, any of a fare to be charged to a passenger when the passenger is transported individually, a travel distance by which the vehicle travels when the passenger is transported individually, and a travel time required for the vehicle to travel when the passenger is transported individually is calculated as individual utility. The riding time in which the passenger is on board on a route from a point where a first passenger, among the plurality of passengers, is picked up to a point where a last passenger is dropped off is calculated as a burden share for ridesharing. Then, the utility is calculated based on the individual utility and the burden share for ridesharing.

Therefore, the longer the riding time of a passenger, that is, the time during which the passenger rides together with another passenger is, the lower the utility is and the less the burden of the fare is. On the other hand, the shorter the riding time of a passenger, that is, the time during which the passenger rides together with another passenger is, the higher the utility is and the more the burden of the fare is. Therefore, the fare can be fairly charged in accordance with the riding time of the passenger.

(5) In the information processing method according to (2) or (3), the utility may be calculated based on individual utility obtained by any of a fare to be charged to a passenger when the passenger is transported individually, a travel distance by which the vehicle travels when the passenger is transported individually, and a travel time required for the vehicle to travel when the passenger is transported individually, and a burden share for ridesharing obtained by a number of other passengers with whom the passenger rides together and a riding time in accordance with the number of other passengers on a route from a point where a first passenger, among the plurality of passengers, is picked up to a point where a last passenger is dropped off.

According to this configuration, any of a fare to be charged to a passenger when the passenger is transported individually, a travel distance by which the vehicle travels when the passenger is transported individually, and a travel time required for the vehicle to travel when the passenger is transported individually is calculated as individual utility. The burden share for ridesharing is calculated based on the number of other passengers with whom the passenger rides together and the riding time in accordance with the number of other passengers on a route from a point where a first passenger, among the plurality of passengers, is picked up to a point where a last passenger is dropped off. Then, the utility is calculated based on the individual utility and the burden share for ridesharing.

Therefore, since the utility is calculated in consideration of not only the riding time for riding together with other passengers but also the number of other passengers who ride together, it is possible to charge the fare more fairly to each of the plurality of passengers who ride together.

(6) In the information processing method according to (4) or (5), the utility may be calculated for each of the plurality of passengers based on following Equation (1):

$$Utility = individual utility - α * burden share for ridesharing \qquad ( 1 )$$

where the α may be a predetermined coefficient.

According to this configuration, the utility is calculated by subtracting the burden share for ridesharing multiplied by the predetermined coefficient from the individual utility.

(7) The information processing method according to any one of (1) to (6) may further include multiplying the total ridesharing fare by a discount coefficient, and calculating the fare may include calculating, as a fare to be charged to each passenger, an amount obtained by distributing the total ridesharing fare multiplied by the discount coefficient to the plurality of passengers in accordance with a ratio of the utility of each of the plurality of passengers.

According to this configuration, by changing the discount coefficient multiplied by the total ridesharing fare, it is possible to change the fare to be charged to each of the plurality of passengers.

(8) In the information processing method according to (7), the discount coefficient may be stored in advance.

According to this configuration, it is possible to calculate the fare to be charged to each of the plurality of passengers using a discount coefficient that is a predetermined fixed value.

(9) The information processing method according to (7) may further include: calculating an individual fare to be charged to each of the plurality of passengers when each of the plurality of passengers is transported individually; calculating an expected fare in which a highest individual fare among a plurality of individual fares having been calculated is multiplied by a predetermined coefficient a (a is a real number larger than 1); and calculating the discount coefficient by dividing, by the total ridesharing fare, the expected fare having been calculated.

According to this configuration, the expected fare is a fare obtained by the transport operator or the driver, and by setting the expected fare to be higher than the highest individual fare, the benefit of the transport operator or the driver is higher when transporting a plurality of passengers together than when individually transporting passengers. As a result, the transport operator or the driver is facilitated to actively perform the ridesharing service, and the ridesharing service can be more widely used.

(10) The information processing method according to (7) may further include: calculating an individual fare to be charged to each of the plurality of passengers when each of the plurality of passengers is transported individually; calculating an expected fare in which a sum of a plurality of individual fare having been calculated is multiplied by a predetermined coefficient b (b is a real number larger than 0 and equal to or smaller than 1); and calculating the discount coefficient by dividing, by the total ridesharing fare, the expected fare having been calculated. According to this configuration, the expected fare is a fare paid by a plurality of passengers, and the expected fare is set to be lower than the sum of the plurality of individual fares, thereby avoiding the plurality of passengers from losing money. As a result, the passenger is facilitated to actively use the ridesharing service, and the ridesharing service can be more widely used.

(11) The information processing method according to any one of (1) to (10) may further include: generating a fare presentation image for presenting the fare having been calculated; and outputting the fare presentation image having been generated.

According to this configuration, by viewing the fare presentation image, each passenger can confirm the fare to be paid by the passenger himself/herself.

(12) The information processing method according to (11) may further include receiving dispatch request information including the boarding point and the alighting point transmitted by a driver terminal operated by a driver who drives the vehicle or a passenger terminal operated by each of the plurality of passengers, generating the fare presentation image may include, upon receiving the dispatch request information, generating a scheduled fare presentation image for presenting, as a scheduled fare to be charged to each passenger, the fare having been calculated, and outputting the fare presentation image may include transmitting the scheduled fare presentation image having been generated to the driver terminal or the passenger terminal.

According to this configuration, upon receiving the dispatch request information including the boarding point and the alighting point, the fare having been calculated is presented as the scheduled fare to be charged to each passenger. Therefore, each passenger can know in advance the fare to be paid by the passenger himself/herself.

(13) The information processing method according to (11), generating the fare presentation image may include generating a fixed fare presentation image for presenting the fare having been calculated to one passenger who alights among the plurality of passengers as a fixed fare to be charged to the one passenger when the one passenger alights, and outputting the fare presentation image may include transmitting the fixed fare presentation image having been generated to a driver terminal operated by a driver who drives the vehicle or a passenger terminal operated by the one passenger.

According to this configuration, the fare having been calculated is presented to one passenger who alights among the plurality of passengers as a fixed fare to be charged to the one passenger when the one passenger alights. Therefore, the passenger can know the fare paid by the passenger himself/herself when alighting.

(14) The information processing method according to (11) may further include determining whether or not a last passenger, among the plurality of passengers, has alighted, acquiring the boarding point and the alighting point may include acquiring the boarding point, the alighting point, a boarding time, and an alighting time of each of the plurality of passengers when determining that the last passenger has alighted, calculating the utility may include calculating the utility of each of the plurality of passengers based on the boarding point, the alighting point, the boarding time, and the alighting time of each passenger, generating the fare presentation image may include generating a plurality of fixed fare presentation images for presenting the fare of each of the plurality of passengers having been calculated to each of the plurality of passengers as a fixed fare to be charged to each passenger, and outputting the fare presentation image may include transmitting the plurality of fixed fare presentation images having been generated to a driver terminal operated by a driver who drives the vehicle or a plurality of passenger terminals operated by each of the plurality of passengers.

According to this configuration, when the last passenger, among the plurality of passengers, alights, the fare of each of the plurality of passengers is calculated, and the fare of each of the plurality of passengers having been calculated is presented to each of the plurality of passengers as the fixed fare to be charged to each passenger. Therefore, a more accurate fare can be charged.

The present disclosure not only can be implemented as an information processing method for executing the characteristic processing as described above, but also can be implemented as an information processing device or the like including a characteristic configuration corresponding to the characteristic processing executed by the information processing method. The present disclosure can also be implemented as a computer program that causes a computer to execute characteristic processing included in the information processing method described above. Therefore, even other aspects below can achieve effects similar to those in the above information processing method.

(15) An information processing device according to another aspect of the present disclosure includes: an acquisition part that acquires a boarding point and an alighting point of each of a plurality of passengers riding together in a vehicle; a utility calculation part that calculates utility enjoyed by each of the plurality of passengers for a ridesharing service based on the boarding point and the alighting point of each passenger; a total ridesharing fare calculation part that calculates a total ridesharing fare for transportation through a route from a point where a first passenger, among the plurality of passengers, is picked up to a point where a last passenger is dropped off; and a fare calculation part that calculates, as a fare to be charged to each passenger, an amount obtained by distributing the total ridesharing fare to the plurality of passengers in accordance with a ratio of the utility of each of the plurality of passengers.

(16) An information processing program according to another aspect of the present disclosure causes a computer to function to: acquire a boarding point and an alighting point of each of a plurality of passengers riding together in a vehicle; calculate utility enjoyed by each of the plurality of passengers for a ridesharing service based on the boarding point and the alighting point of each passenger; calculate a total ridesharing fare for transportation through a route from a point where a first passenger, among the plurality of passengers, is picked up to a point where a last passenger is dropped off; and calculate, as a fare to be charged to each passenger, an amount obtained by distributing the total ridesharing fare to the plurality of passengers in accordance with a ratio of the utility of each of the plurality of passengers.

(17) A non-transitory computer-readable recording medium according to another aspect of the present disclosure records an information processing program, the information processing program causing a computer to function to: acquire a boarding point and an alighting point of each of a plurality of passengers riding together in a vehicle; calculate utility enjoyed by each of the plurality of passengers for a ridesharing service based on the boarding point and the alighting point of each passenger; calculate a total ridesharing fare for transportation through a route from a point where a first passenger, among the plurality of passengers, is picked up to a point where a last passenger is dropped off; and calculate, as a fare to be charged to each passenger, an amount obtained by distributing the total ridesharing fare to the plurality of passengers in accordance with a ratio of the utility of each of the plurality of passengers.

Embodiments of the present disclosure will be described below with reference to the accompanying drawings. Note that the following embodiments are examples embodying the present disclosure, and are not intended to limit a technical scope of the present disclosure.

### First Embodiment

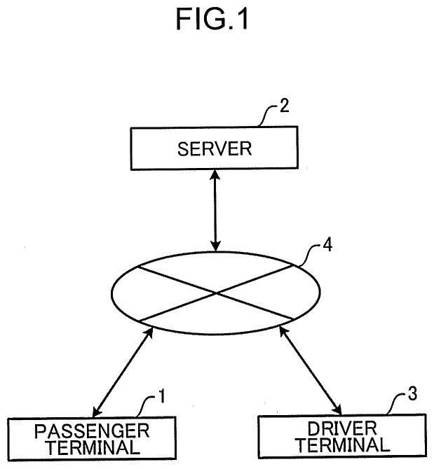

FIG. 1 is a view illustrating an overall configuration of a transportation system in the first embodiment of the present disclosure.

The transportation system illustrated in FIG. 1 includes a passenger terminal 1, a server 2, and a driver terminal 3.

The passenger terminal 1 is, for example, a smartphone or a tablet computer, and is operated by a passenger on board a vehicle. The vehicle is, for example, a shared taxi or a private car driven by an ordinary person dispatched by a dispatch platform. The vehicle provides a ridesharing service for transporting a plurality of passengers with different alighting points. The passenger boards the vehicle at a desired place and alights from the vehicle at a destination. The passenger terminal 1 is communicably connected to the server 2 via a network 4. The network 4 is the Internet, for example.

The passenger terminal 1 receives an input by the passenger of a vehicle dispatch request, and transmits dispatch request information for requesting dispatch of a vehicle to the server 2. The passenger terminal 1 receives an input of a boarding point and an alighting point (destination) by the passenger. The boarding point is a place where a passenger boards the vehicle. The boarding point is a current position of the passenger. The boarding point may be a place arbitrarily designated by the passenger.

For example, the passenger terminal 1 may display a map and receive an input by the passenger of an arbitrary boarding point and an arbitrary alighting point on the displayed map. The passenger terminal 1 may receive an input by the passenger of addresses of an arbitrary boarding point and an arbitrary alighting point.

The passenger terminal 1 transmits, to the server 2, information for identifying the passenger, and dispatch request information including a boarding point and an alighting point. The information for identifying the passenger may be a user ID for identifying the passenger or a terminal ID for identifying the passenger terminal 1.

Note that, in a case where the passenger terminal 1 includes a global positioning system (GPS) receiver, the passenger terminal 1 may transmit, to the server 2, dispatch request information in which the current position acquired by the GPS receiver is set as a boarding point.

The server 2 creates a transportation route of the vehicle for transporting a plurality of passengers from the boarding point to the alighting point, and calculates a fare to be charged to each of the plurality of passengers. The server 2 is communicably connected to the passenger terminal 1 and the driver terminal 3 via the network 4. The server 2 transmits information indicating the created transportation route to the driver terminal 3. The server 2 transmits information indicating the fare to be charged for each of the plurality of passengers to the passenger terminal 1 of each of the plurality of passengers or the driver terminal 3.

The passenger terminal 1 receives the information indicating the fare to be charged to the passenger transmitted by the server 2. The passenger terminal 1 displays the fare of the passenger having been received. Due to this, the passenger terminal 1 presents the fare to the passenger.

The driver terminal 3 is a terminal operated by the driver, and is, for example, a smartphone or a tablet computer. The driver terminal 3 transmits the current position of the vehicle to the server 2. The driver terminal 3 transmits the current position acquired by the GPS receiver to the server 2 as the current position of the vehicle. Note that the vehicle may transmit the current position to the server 2.

The driver terminal 3 receives the information indicating the transportation route transmitted by the server 2. The driver terminal 3 displays the received transportation route. Due to this, the driver terminal 3 presents the transportation route to the driver of the vehicle. The driver moves the vehicle in accordance with the transportation route displayed on the driver terminal 3. The driver terminal 3 receives the information indicating the fare to be charged to each of the plurality of passengers transmitted by the server 2. The driver terminal 3 displays the fare of each of the plurality of passengers having been received. Due to this, the driver terminal 3 presents the fare to the driver of the vehicle and each of the plurality of passengers.

Note that the boarding patterns in which a plurality of passengers board the vehicle include a first boarding pattern in which a plurality of passengers board from different boarding points and a second boarding pattern in which a plurality of passengers board from the same boarding point. The boarding point in the second boarding pattern is a predetermined waiting place such as a taxi stand, for example. A plurality of passengers waiting at the same boarding point rides together in one vehicle.

In the first boarding pattern, the passenger terminal 1 receives an input by the passenger of the boarding point and the alighting point, and transmits dispatch request information including the boarding point and the alighting point to the server 2. On the other hand, in the second boarding pattern, the driver terminal 3 receives an input by the driver of the boarding point and the alighting point, and transmits dispatch request information including the boarding point and the alighting point to the server 2.

Therefore, the driver terminal 3 receives an input by the driver of a vehicle dispatch request, and transmits dispatch request information for requesting vehicle dispatch to the server 2. The driver confirms the alighting point for each of the plurality of passengers. The driver terminal 3 receives an input by the driver of the boarding point and the alighting point (destination). The boarding point is a place where a plurality of passengers board the vehicle.

For example, the driver terminal 3 may display a map and receive an input by the driver of an arbitrary boarding point and an arbitrary alighting point on the displayed map. The driver terminal 3 may receive an input by the driver of addresses of an arbitrary boarding point and an arbitrary alighting point.

The driver terminal 3 transmits, to the server 2, information for identifying each of the plurality of passengers, and dispatch request information including the boarding point and a plurality of alighting points.

Note that, in a case where the driver terminal 3 includes a GPS receiver, the driver terminal 3 may transmit, to the server 2, dispatch request information in which the current position acquired by the GPS receiver is set as a boarding point.

The driver terminal 3 may be a terminal provided in the vehicle. When the vehicle is an automatic driving vehicle, the server 2 may transmit information indicating the created transportation route to the vehicle. In this case, the vehicle may travel in accordance with the received transportation route.

The transportation system may include a plurality of the passenger terminals 1 operated by a plurality of respective passengers and a plurality of the driver terminals 3 operated by a plurality of respective drivers.

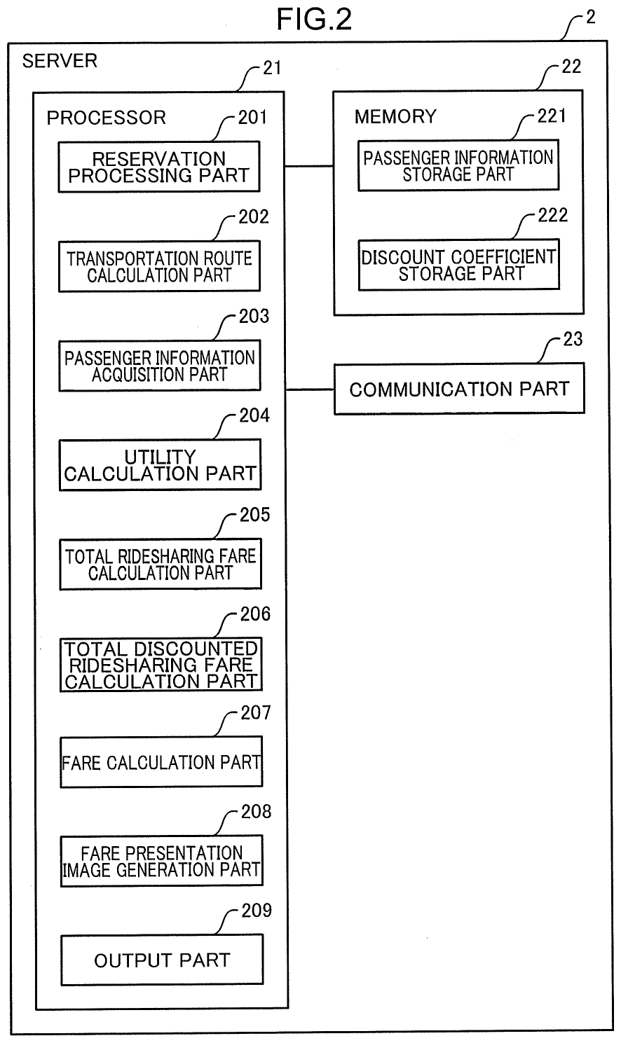

FIG. 2 is a block diagram illustrating the configuration of the server 2 in the first embodiment of the present disclosure.

The server 2 includes a processor 21, a memory 22, and a communication part 23.

The processor 21 is, for example, a central processing unit (CPU). The processor 21 implements a reservation processing part 201, a transportation route calculation part 202, a passenger information acquisition part 203, a utility calculation part 204, a total ridesharing fare calculation part 205, a total discounted ridesharing fare calculation part 206, a fare calculation part 207, a fare presentation image generation part 208, and an output part 209.

The memory 22 is a storage device that can store various types of information, such as a random access memory (RAM), a hard disk drive (HDD), a solid state drive (SSD), or a flash memory. The memory 22 implements a passenger information storage part 221 and a discount coefficient storage part 222.

Note that the reservation processing part 201 to the output part 209, the passenger information storage part 221, and the discount coefficient storage part 222 may be configured with a dedicated hardware circuit. The reservation processing part 201 to the output part 209, the passenger information storage part 221, and the discount coefficient storage part 222 may be dispersedly arranged in a plurality of devices.

The reservation processing part 201 acquires, via the communication part 23, boarding points and alighting points of a plurality of passengers from the plurality of passenger terminals 1 or the driver terminal 3. The communication part 23 receives the dispatch request information transmitted by each of the plurality of passenger terminals 1. The communication part 23 receives the dispatch request information transmitted by the driver terminal 3. The dispatch request information includes information for identifying the passenger, the boarding point of the passenger, and the alighting point of the passenger. The reservation processing part 201 stores, in the passenger information storage part 221 in association with the passenger, the boarding point and the alighting point included in the dispatch request information received by communication part 23.

The passenger information storage part 221 stores the boarding point and the alighting point in association with the passenger. The passenger information storage part 221 stores the boarding point and the alighting point for each passenger. The boarding point and the alighting point are represented by latitude and longitude. The boarding point and the alighting point may be represented by an address or a facility name.

The transportation route calculation part 202 calculates a transportation route of at least one vehicle for transporting a plurality of passengers from a boarding point to an alighting point based on the current position of at least one vehicle and the boarding point and the alighting point of the plurality of passengers. The transportation route calculation part 202 calculates the transportation route of the vehicle using, for example, at least one of cross exchange local search, 2-opt local search, and in-route insertion local search.

The passenger information acquisition part 203 acquires the boarding point and the alighting point of each of the plurality of passengers riding together in the vehicle. The passenger information acquisition part 203 acquires, from the passenger information storage part 221, the boarding point and the alighting point of each of the plurality of passengers riding together in the vehicle whose transportation route is calculated by the transportation route calculation part 202.

The utility calculation part 204 calculates the utility enjoyed by each of the plurality of passengers for the ridesharing service based on the boarding point and the alighting point of each passenger. The utility indicates the satisfaction level of each of the plurality of passengers with the ridesharing service. The utility is a value that increases as a time for riding together with another passenger decreases, and that decreases as the time for riding together with another passenger increases.

The utility is calculated based on individual utility obtained by a fare to be charged to the passenger when the passenger is transported individually, and a burden share for ridesharing obtained by a riding time in which the passenger is on board on a route from a point where a first passenger, among the plurality of passengers, is picked up to a point where a last passenger is dropped off. The utility calculation part 204 calculates the utility for each of the plurality of passengers based on the following Equation (2).

$$Utility = individual utility - α * burden share for ridesharing \qquad ( 2 )$$

In the above Equation (2), the individual utility is a fare to be charged to the passenger when the passenger is transported individually, a is a predetermined coefficient, and the burden share for ridesharing is a riding time in which the passenger is on board on a route from a point where a first passenger, among the plurality of passengers, is picked up to a point where a last passenger is dropped off.

The utility calculation part 204 calculates, as individual utility, a fare to be charged to the passenger when the passenger is transported individually on the optimum transportation route. First, the utility calculation part 204 calculates the optimum transportation route in a case where passengers are transported individually. The optimum transportation route is a transportation route having the shortest travel distance from the boarding point to the alighting point or a transportation route having the shortest travel time from the boarding point to the alighting point. Note that the optimum transportation route is calculated using an existing route search algorithm. Next, the utility calculation part 204 calculates the travel distance and the travel time of the optimum transportation route having been calculated. Next, the utility calculation part 204 calculates the fare of the passenger using the travel distance and the travel time having been calculated.

For example, when the vehicle is a taxi, a calculation method of a taxi fare is used for calculation of the fare. The taxi fare includes a distance-based fare. The distance-based fare includes an initial fare and an additional fare. The initial fare is a minimum fare paid until the distance traveled by a taxi reaches a predetermined initial distance. The additional fare is a fare added in accordance with the length of the distance traveled by the taxi. Note that the taxi fare is calculated using an existing taxi fare calculation method. The taxi fare may include a distance-based fare and a time-distance-based fare. The time-distance-based fare is a fare added in accordance with the length of time during which the taxi travels at equal to or less than a predetermined speed.

That is, the utility calculation part 204 determines whether or not the travel distance of the optimum transportation route is equal to or less than the initial distance of the initial fare. When the travel distance of the optimum transportation route is equal to or less than the initial distance, the utility calculation part 204 calculates the initial fare as the fare of the passenger. On the other hand, when the travel distance of the optimum transportation route is longer than the initial distance, the utility calculation part 204 calculates the additional fare by using a distance in which the initial distance is subtracted from the travel distance of the optimum transportation route. Then, the utility calculation part 204 calculates, as the fare of the passenger, an amount obtained by adding the initial fare and the additional fare.

Note that in the first embodiment, the utility calculation part 204 calculates, as individual utility, the fare to be charged to the passenger when the passenger is transported individually, but the present disclosure is not particularly limited to this, and the utility calculation part 204 may calculate, as individual utility, the travel distance in which the vehicle travels when the passenger is transported individually or the travel time required for the vehicle to travel when the passenger is transported individually.

Subsequently, the utility calculation part 204 calculates the optimum transportation route in a case of transporting the plurality of passengers. The optimum transportation route is a transportation route having the shortest travel distance from the boarding point of the first passenger to the alighting point of the last passenger, or a transportation route having the shortest travel time from the boarding point of the first passenger to the alighting point of the last passenger. Note that the optimum transportation route is calculated using an existing route search algorithm. The utility calculation part 204 may use the optimum transportation route in a case of transporting the plurality of passengers calculated by the transportation route calculation part 202. Next, the utility calculation part 204 calculates the riding time in which each passenger is on board on the optimum transportation route having been calculated. The utility calculation part 204 calculates the travel distance of each passenger in the optimum transportation route having been calculated and calculates a travel speed of each passenger. The travel speed is, for example, an average legal speed of the transportation route of each passenger. The utility calculation part 204 calculates the riding time of each passenger as the burden share for ridesharing by dividing the travel distance of each passenger having been calculated by the ravel speed of each passenger having been calculated.

Note that the utility calculation part 204 may calculate, as the burden share for ridesharing, the time during which the passenger rides together with another passenger in the riding time in which the passenger is on board.

Subsequently, the utility calculation part 204 calculates the utility by subtracting, from the individual utility, a value in which the burden share for ridesharing is multiplied by the predetermined coefficient α.

The total ridesharing fare calculation part 205 calculates a total ridesharing fare for transportation through a route from a point where a first passenger, among the plurality of passengers, is picked up to a point where a last passenger is dropped off. The total ridesharing fare calculation part 205 calculates a total ridesharing fare charged to an arbitrary passenger when the vehicle transports the arbitrary passenger through the route from the point where the first passenger, among the plurality of passengers, is picked up to the point where the last passenger is dropped off. The total ridesharing fare calculation part 205 calculates the optimum transportation route in a case of transporting the plurality of passengers. The optimum transportation route is a transportation route having the shortest travel distance from the boarding point of the first passenger to the alighting point of the last passenger, or a transportation route having the shortest travel time from the boarding point of the first passenger to the alighting point of the last passenger. Note that the optimum transportation route is calculated using an existing route search algorithm. The total ridesharing fare calculation part 205 may use the optimum transportation route in a case of transporting a plurality of passengers calculated by the transportation route calculation part 202 or the utility calculation part 204. Next, the total ridesharing fare calculation part 205 calculates the travel distance and the travel time of the optimum transportation route having been calculated. Next, the total ridesharing fare calculation part 205 calculates a fare of an arbitrary passenger by using the travel distance and the travel time having been calculated. Note that the calculation method of the fare by the total ridesharing fare calculation part 205 is the same as the calculation method of the fare of the passenger by the utility calculation part 204.

The discount coefficient storage part 222 stores a discount coefficient in advance. The discount coefficient is preset by the transport operator or the driver.

The total discounted ridesharing fare calculation part 206 reads the discount coefficient from the discount coefficient storage part 222. The total discounted ridesharing fare calculation part 206 multiplies the total ridesharing fare calculated by the total ridesharing fare calculation part 205 by the discount coefficient.

The fare calculation part 207 calculates, as a fare to be charged to each passenger, an amount obtained by distributing the total ridesharing fare multiplied by the discount coefficient to the plurality of passengers in accordance with a ratio of the utility of each of the plurality of passengers.

Note that in the first embodiment, the total ridesharing fare is multiplied by the discount coefficient, but the present disclosure is not particularly limited to this, and the total ridesharing fare needs not be multiplied by the discount coefficient. In this case, the discount coefficient storage part 222 and the total discounted ridesharing fare calculation part 206 are unnecessary. Then, the fare calculation part 207 may calculate, as a fare to be charged to each passenger, an amount obtained by distributing the total ridesharing fare to the plurality of passengers in accordance with a ratio of the utility of each of the plurality of passengers.

The fare presentation image generation part 208 generates a fare presentation image for presenting the fare calculated by the fare calculation part 207. More specifically, upon receiving dispatch request information, the fare presentation image generation part 208 generates a scheduled fare presentation image for presenting, as a scheduled fare to be charged to each passenger, the fare of each passenger calculated by the fare calculation part 207. When one passenger among the plurality of passengers alights, the fare presentation image generation part 208 generates a fixed fare presentation image for presenting the fare calculated by the fare calculation part 207 to the one passenger as a fixed fare to be charged to the one passenger who alights.

The output part 209 outputs a fare presentation image generated by the fare presentation image generation part 208. The output part 209 transmits, via the communication part 23, a scheduled fare presentation image generated by the fare presentation image generation part 208 to the driver terminal 3 or the passenger terminal 1 of each passenger. The output part 209 transmits, via the communication part 23, a fixed fare presentation image generated by the fare presentation image generation part 208 to the driver terminal 3 operated by the driver who drives the vehicle or the passenger terminal 1 operated by one passenger.

The communication part 23 transmits, to the driver terminal 3 or the passenger terminal 1, a scheduled fare presentation image generated by the fare presentation image generation part 208. The communication part 23 transmits, to the driver terminal 3 or the passenger terminal 1, a fixed fare presentation image generated by the fare presentation image generation part 208.

Next, the fare calculation processing of the server 2 in the first embodiment of the present disclosure will be described.

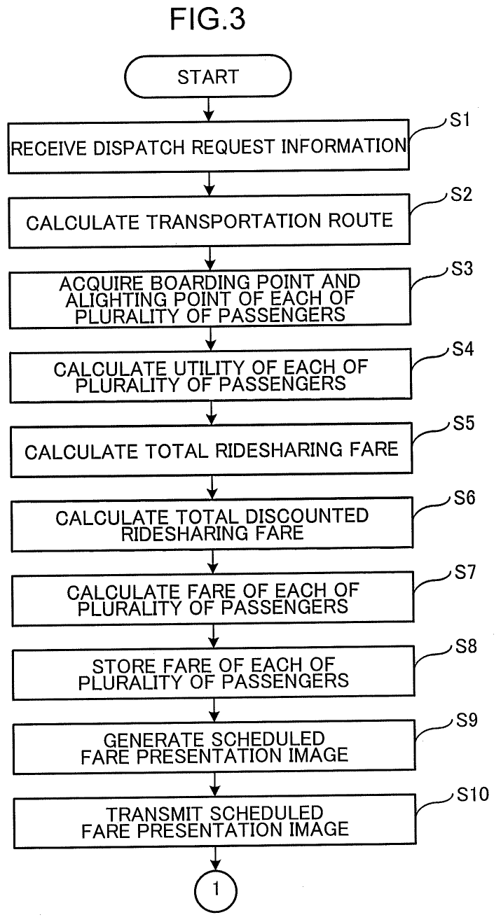

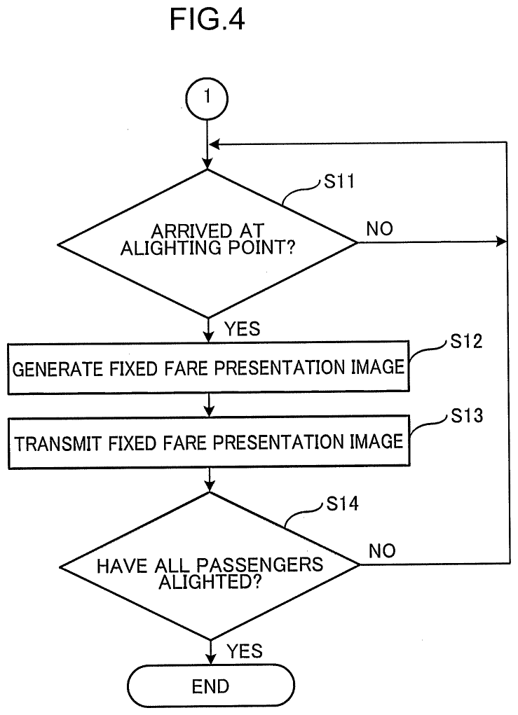

FIG. 3 is the first flowchart for explaining the fare calculation processing of the server 2 in the first embodiment of the present disclosure, and FIG. 4 is the second flowchart for explaining the fare calculation processing of the server 2 in the first embodiment of the present disclosure.

First, in step S1, the communication part 23 receives dispatch request information transmitted by the driver terminal 3 or each of the plurality of passenger terminals 1. The reservation processing part 201 stores, in the passenger information storage part 221 in association with the passenger, the boarding point and the alighting point included in the dispatch request information received by communication part 23.

Next, in step S2, the transportation route calculation part 202 calculates a transportation route of at least one vehicle for transporting the plurality of passengers from the boarding point to the alighting point based on the current position of at least one vehicle, and the boarding point and the alighting point of the plurality of passengers. In the first boarding pattern, the transportation route calculation part 202 determines a combination of a vehicle and a plurality of passengers riding together in the vehicle, and calculates an optimum transportation route through boarding points and alighting points of the plurality of passengers from the current position of the vehicle. In the second boarding pattern, the transportation route calculation part 202 determines a combination of a vehicle and a plurality of passengers riding together in the vehicle, and calculates an optimum transportation route through alighting points of the plurality of passengers from the current position of the vehicle (boarding points of the plurality of passengers).

The optimum transportation route is a transportation route having the shortest travel distance from the boarding point of the first passenger to the alighting point of the last passenger, or a transportation route having the shortest travel time from the boarding point of the first passenger to the alighting point of the last passenger. Note that the optimum transportation route is calculated using an existing route search algorithm.

Note that the communication part 23 transmits, to the driver terminal 3, information indicating the transportation route created by the transportation route calculation part 202. The driver terminal 3 displays the received transportation route. The driver moves the vehicle in accordance with the transportation route displayed on the driver terminal 3.

Next, in step S3, the passenger information acquisition part 203 acquires, from the passenger information storage part 221, the boarding point and the alighting point of each of the plurality of passengers riding together in the vehicle.

Next, in step S4, the utility calculation part 204 calculates the utility indicating the satisfaction level of each of the plurality of passengers with the ridesharing service based on the boarding point and the alighting point of each passenger. The utility calculation part 204 calculates the utility of each of the plurality of passengers based on the above Equation (2).

Next, in step S5, the total ridesharing fare calculation part 205 calculates a total ridesharing fare charged to an arbitrary passenger when the vehicle transports the arbitrary passenger through the route from the point where the first passenger, among the plurality of passengers, is picked up to the point where the last passenger is dropped off. That is, the total ridesharing fare calculation part 205 calculates, as the total ridesharing fare, a fare in a case where the vehicle transports only one passenger on a route from the point where the first passenger is picked up to the point where the last passenger is dropped off, among the optimum transportation routes in a case of transporting the plurality of passengers. For example, when the vehicle picks up a first passenger at a first point, picks up a second passenger at a second point, drops off the first passenger at a third point, and drops off the second passenger at a fourth point, the total ridesharing fare calculation part 205 calculates the fare from the first point to the fourth point as the total ridesharing fare.

Next, in step S6, the total discounted ridesharing fare calculation part 206 reads the discount coefficient from the discount coefficient storage part 222, and calculates the total discounted ridesharing fare in which the total ridesharing fare calculated by the total ridesharing fare calculation part 205 is multiplied by the discount coefficient.

Next, in step S7, the fare calculation part 207 calculates, as a fare of each of the plurality of passengers, an amount obtained by distributing the total discounted ridesharing fare to the plurality of passengers in accordance with a ratio of the utility of each of the plurality of passengers.

Next, in step S8, the fare calculation part 207 stores the fare of each of the plurality of passengers having been calculated in the passenger information storage part 221.

Next, in step S9, the fare presentation image generation part 208 generates a scheduled fare presentation image for presenting, as a scheduled fare to be charged to each passenger, the fare of each passenger calculated by the fare calculation part 207. The fare presentation image generation part 208 generates a scheduled fare presentation image of each of the plurality of passengers.

Next, in step S10, the output part 209 transmits, via the communication part 23, the scheduled fare presentation image generated by the fare presentation image generation part 208 to the driver terminal 3 or the passenger terminal 1 of each passenger. When the communication part 23 receives dispatch request information from the driver terminal 3, the output part 209 transmits the scheduled fare presentation image to the driver terminal 3. When the communication part 23 receives dispatch request information from the passenger terminal 1 of each passenger, the output part 209 transmits the scheduled fare presentation image to the passenger terminal 1 of each passenger.

The driver terminal 3 or the passenger terminal 1 of each passenger receives a scheduled fare presentation image transmitted by the server 2, and displays the scheduled fare presentation image having been received.

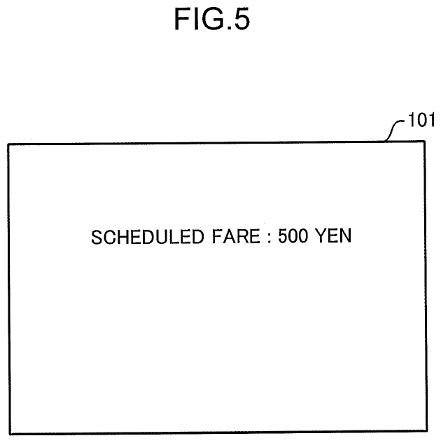

FIG. 5 is a view illustrating an example of a scheduled fare presentation image displayed on the passenger terminal 1 of each passenger in the first embodiment.

The scheduled fare presentation image 101 illustrated in FIG. 5 includes a fare scheduled to be paid by the passenger who uses the passenger terminal 1. A display part of the passenger terminal 1 displays the scheduled fare presentation image 101. By confirming the scheduled fare presentation image 101 displayed on the passenger terminal 1, the passenger can know the fare scheduled to be paid by the passenger himself/herself.

Note that when the display part of the driver terminal 3 displays the scheduled fare presentation image 101, the scheduled fare presentation image 101 may include the fare scheduled to be paid by each of the plurality of passengers. When a plurality of passengers board at the same time, the driver terminal 3 may collectively display the fare of each of the plurality of passengers.

Returning to FIG. 4, next, in step S11, the fare presentation image generation part 208 determines whether or not the vehicle has arrived at the alighting point. The driver terminal 3 may receive an input by the driver as to whether or not the vehicle has arrived at the alighting point. When the vehicle arrives at the alighting point and the passenger alights, the driver touches an alighting button displayed on the driver terminal 3. When the alighting button is touched, the driver terminal 3 transmits an alighting reception signal to the server 2. The fare presentation image generation part 208 determines whether the vehicle has arrived at the alighting point based on whether or not the alighting reception signal has been received. The alighting reception signal may include information for identifying the alighting passenger or position information of the alighting point. The communication part 23 of the server 2 receives the alighting reception signal transmitted by the driver terminal 3. The fare presentation image generation part 208 recognizes which passenger, among the plurality of passengers, alights based on the information for identifying the passenger included in the alighting reception signal.

Note that, in a case where the alighting reception signal includes position information of the alighting point, the fare presentation image generation part 208 may recognize which passenger, among the plurality of passengers, alights by referring to the passenger information storage part 221 and specifying the passenger corresponding to the alighting point matching the position information included in the alighting reception signal.

Here, when it is determined that the vehicle has not arrived at the alighting point (NO in step S11), the determination in step S11 is performed again.

On the other hand, when it is determined that the vehicle has arrived at the alighting point (YES in step S11), the fare presentation image generation part 208 generates in step S12 a fixed fare presentation image for presenting, to one passenger who alights, the fare calculated by the fare calculation part 207 to the one passenger as a fixed fare to be charged. At this time, the fare presentation image generation part 208 generates a fixed fare presentation image for presenting, as a fixed fare to be charged to the alighting passenger, the passenger with the fare of the alighting passenger stored in the passenger information storage part 221. That is, the fixed fare to be charged to the passenger is the same as the scheduled fare calculated when the passenger requests dispatch. The fare presentation image generation part 208 generates a fixed fare presentation image of the alighting passenger.

Next, in step S13, the output part 209 transmits, via the communication part 23, the fixed fare presentation image generated by the fare presentation image generation part 208 to the driver terminal 3 or the passenger terminal 1 of the alighting passenger. When the communication part 23 receives the dispatch request information from the driver terminal 3, the output part 209 transmits the fixed fare presentation image to the driver terminal 3. When the communication part 23 receives the dispatch request information from the passenger terminal 1 of each passenger, the output part 209 transmits the fixed fare presentation image to the passenger terminal 1 of the alighting passenger.

The driver terminal 3 or the passenger terminal 1 of the alighting passenger receives the fixed fare presentation image transmitted by the server 2, and displays the fixed fare presentation image having been received.

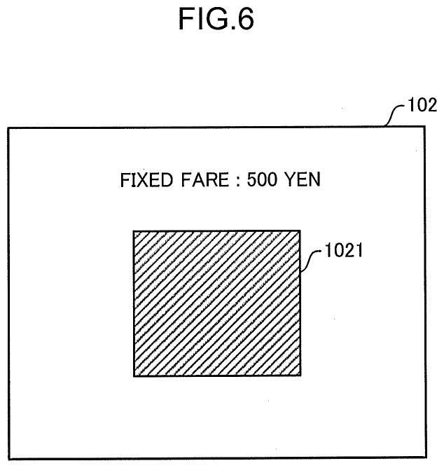

FIG. 6 is a view illustrating an example of a fixed fare presentation image displayed on the passenger terminal 1 of the alighting passenger in the first embodiment.

A fixed fare presentation image 102 illustrated in FIG. 6 includes a fixed fare to be paid by the passenger who uses the passenger terminal 1. The display part of the passenger terminal 1 displays the fixed fare presentation image 102. By confirming the fixed fare presentation image 102 displayed on the passenger terminal 1, the passenger can know the fare to be paid by the passenger himself/herself. The fixed fare presentation image 102 may also include a two-dimensional code 1021 for collecting the fare. The fare may be collected by the driver terminal 3 reading the two-dimensional code 1021.

Note that the display part of the driver terminal 3 may display the fixed fare presentation image 102.

Next, in step S14, the fare presentation image generation part 208 determines whether or not all the passengers riding together in the vehicle have alighted. Here, when it is determined that not all the passengers have alighted (NO in step S14), the processing returns to step S11.

On the other hand, when it is determined that all the passengers have alighted (YES in step S14), the fare calculation processing ends.

In this manner, the utility enjoyed by each of the plurality of passengers for a ridesharing service is calculated based on the boarding point and the alighting point of each passenger, and as a fare to be charged to each passenger, the amount obtained by distributing the total ridesharing fare to the plurality of passengers is calculated in accordance with a ratio of the utility of each of the plurality of passengers. Therefore, since the fare of each passenger is calculated in consideration of the utility enjoyed by each of the plurality of passengers for the ridesharing service, it is possible to charge the fare fairly to each of the plurality of passengers who ride together.

Note that although the scheduled fare presentation image 101 and the fixed fare presentation image 102 in the first embodiment include a scheduled fare and a fixed fare, the present disclosure is not particularly limited to this, and may further include a total ridesharing fare, a discount coefficient, a total discounted ridesharing fare, and utility of each passenger.

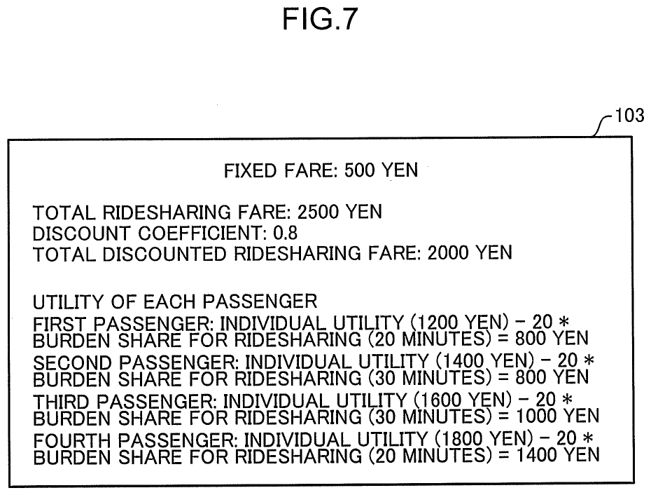

FIG. 7 is a view illustrating another example of the fixed fare presentation image displayed on the passenger terminal 1 of the alighting passenger in the first embodiment.

A fixed fare presentation image 103 illustrated in FIG. 7 includes a fixed fare to be paid by the passenger who uses the passenger terminal 1. The display part of the passenger terminal 1 displays the fixed fare presentation image 103. In addition to the fixed fare, the fixed fare presentation image 103 may include a total ridesharing fare, a discount coefficient, a total discounted ridesharing fare, and utility of each passenger.

In the example of FIG. 7, the total ridesharing fare is 2500 yen, and the discount coefficient is 0.8. total ridesharing fare in which the total discounted ridesharing fare is multiplied by the discount coefficient is 2000 yen. A first passenger, a second passenger, a third passenger, and a fourth passenger ride together in the vehicle, and the third passenger is an alighting passenger. The utility of the first passenger is 800 yen, the utility of the second passenger is 800 yen, the utility of the third passenger is 1000 yen, and the utility of the fourth passenger is 1400 yen. The ratio of the utility of the third passenger is 1/4 (=1000 yen/(800 yen+800 yen+1000 yen+1400 yen)), and the fixed fare of the third passenger is 500 yen (=2000 yen*1/4).

Note that the burden share for ridesharing of the utility in the first embodiment is a riding time in which the passenger is on board on a route from a point where a first passenger, among the plurality of passengers, is picked up to a point where a last passenger is dropped off, but the present disclosure is not particularly limited to this, and the burden share for ridesharing may be a value calculated based on the number of other passengers with whom the passenger rides together and the riding time in accordance with the number of other passengers on a route from a point where a first passenger, among the plurality of passengers, is picked up to a point where a last passenger is dropped off. Specifically, the utility calculation part 204 may calculate the burden share for ridesharing based on the following Equation (3).

$$Burden share for ridesharing = w 1 * ( time for one person on board ) + w 2 * ( time for two persons on board ) + … + wN * ( time for N persons on board ) \qquad ( 3 )$$

In the above Equation (3), w1, w2, . . . , and wN are weighting coefficients for each parameter. w1, w2, . . . , and wN are real numbers of 0 or more, and satisfy w1<w2< . . . <wN. For example, in a case where four passengers ride together, the riding time of one passenger is 70 minutes, the time for the one passenger on board alone is 10 minutes, the time for the one passenger on board with one other is 15 minutes, the time for the one passenger on board with two others is 20 minutes, and the time for the one passenger on board with three others is 25 minutes, the utility calculation part 204 may calculate the burden share for ridesharing based on the following Equation (4).

$$Burden share for ridesharing = w 1 * 10 mins + w 2 * 15 mins + w 3 * 20 mins + w 4 * 25 mins \qquad ( 4 )$$

In this manner, since the utility is calculated in consideration of not only the riding time for riding together with other passengers but also the number of other passengers who ride together, it is possible to charge the fare more fairly to each of the plurality of passengers who ride together.

### Second Embodiment

In the first embodiment, a fare of each passenger is calculated before a plurality of passengers board a vehicle or when a plurality of passengers board the vehicle, and the calculated fare is presented when each passenger alights. On the other hand, in the second embodiment, a fare of each passenger is calculated after the last passenger, among the plurality of passengers, alights, and the calculated fare is presented to each passenger.

The driver terminal 3 in the second embodiment not only receives an input by the driver of a vehicle dispatch request and transmits dispatch request information to the server 2, but also receives an input by the driver of a boarding time at which each of a plurality of passengers boards the vehicle and an alighting time at which each of the plurality of passengers alights and transmits the boarding time and the alighting time to the server 2. When having the passenger to board the vehicle at the boarding point, the driver terminal 3 receives an input by the driver of the boarding time. The driver terminal 3 transmits, to the server 2, boarding information including information for identifying a passenger on board, a boarding point, and a boarding time having been input. The driver terminal 3 receives an input by the driver of the alighting time when having the passenger alighting at the alighting point. The driver terminal 3 transmits, to the server 2, alighting information including information for identifying a passenger having alighted, an alighting point, and an alighting time having been input.

In the first embodiment, the vehicle allows a passenger who has requested dispatch in advance to board the vehicle, but in the second embodiment, the vehicle may allow not only a passenger who has requested dispatch in advance but also a passenger who has not requested dispatch in advance to board the vehicle. That is, in the middle of traveling with passengers on board, the vehicle may pick up other passengers who have not requested dispatch in advance.

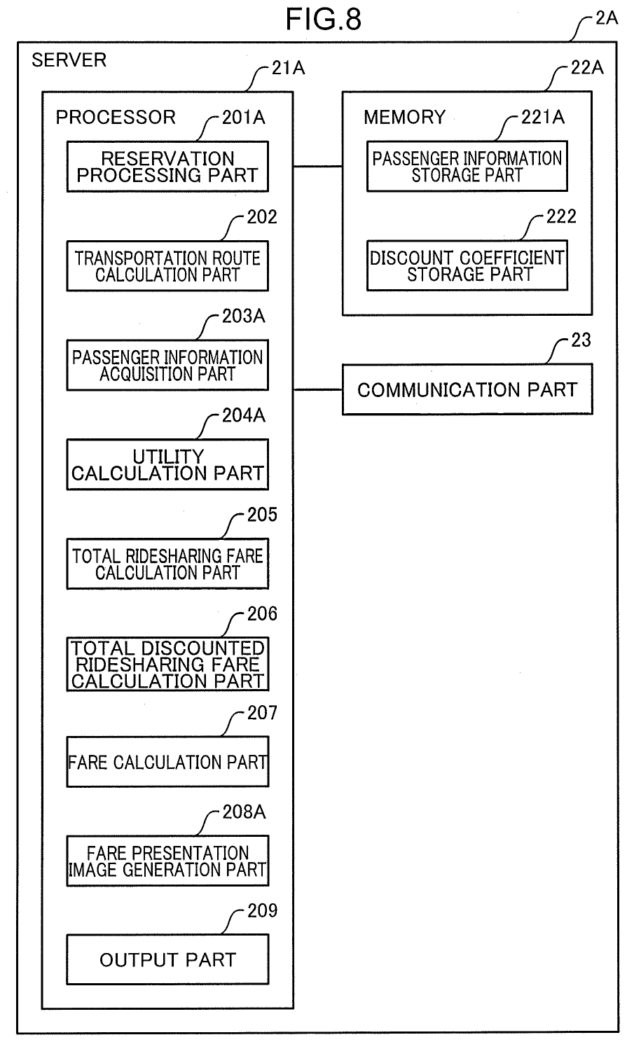

FIG. 8 is a block diagram illustrating the configuration of a server 2A in the second embodiment of the present disclosure.

The server 2A includes a processor 21A, a memory 22A, and the communication part 23. Note that, in the second embodiment, the same configuration as that in the first embodiment will be denoted by the same reference sign as that in the first embodiment, and will be omitted from description.

The processor 21A implements a reservation processing part 201A, the transportation route calculation part 202, a passenger information acquisition part 203A, a utility calculation part 204A, the total ridesharing fare calculation part 205, the total discounted ridesharing fare calculation part 206, the fare calculation part 207, a fare presentation image generation part 208A, and the output part 209.

The memory 22A implements a passenger information storage part 221A and a discount coefficient storage part 222.

Note that the reservation processing part 201A to the output part 209, the passenger information storage part 221A, and the discount coefficient storage part 222 may be configured with a dedicated hardware circuit. The reservation processing part 201A to the output part 209, the passenger information storage part 221A, and the discount coefficient storage part 222 may be dispersedly arranged in a plurality of devices.

The passenger information storage part 221A stores the boarding point, the alighting point, the boarding time, and the alighting time in association with the passenger. The passenger information storage part 221A stores the boarding point, the alighting point, the boarding time, and the alighting time for each passenger. The boarding point and the alighting point are represented by latitude and longitude. The boarding point and the alighting point may be represented by an address or a facility name.

The reservation processing part 201A acquires, via the communication part 23, boarding points and alighting points of a plurality of passengers from the plurality of passenger terminals 1 or the driver terminal 3. The communication part 23 receives the dispatch request information transmitted by each of the plurality of passenger terminals 1. The communication part 23 receives the dispatch request information transmitted by the driver terminal 3. The dispatch request information includes information for identifying the passenger, the boarding point of the passenger, and the alighting point of the passenger. The reservation processing part 201A stores, in the passenger information storage part 221A in association with the passenger, the boarding point and the alighting point included in the dispatch request information received by communication part 23.

The reservation processing part 201A acquires boarding times and alighting times of the plurality of passengers from the driver terminal 3 via the communication part 23. The communication part 23 receives the boarding information and the alighting information transmitted by the driver terminal 3. The boarding information includes information for identifying the passenger, the boarding point, and the boarding time. The alighting information includes information for identifying the passenger, the alighting point, and the alighting time. The reservation processing part 201A stores, in the passenger information storage part 221A in association with the passenger, the boarding point and the boarding time included in the boarding information received by communication part 23. The reservation processing part 201A stores, in the passenger information storage part 221A in association with the passenger, the alighting point and the alighting time included in the alighting information received by communication part 23.

The passenger information acquisition part 203A acquires the boarding point and the alighting point of each of the plurality of passengers riding together in the vehicle that transports the plurality of passengers before the plurality of passengers board the vehicle or when the plurality of passengers board the vehicle.

The passenger information acquisition part 203A determines whether or not the last passenger, among the plurality of passengers riding together in the vehicle, has alighted. When determining that the last passenger has alighted, the passenger information acquisition part 203A acquires the boarding point, the alighting point, the boarding time, and the alighting time of each of the plurality of passengers.

The utility calculation part 204A calculates the utility of each of the plurality of passengers based on the boarding point and the alighting point of each passenger before the plurality of passengers board the vehicle or when the plurality of passengers board the vehicle. When the last passenger, among the plurality of passengers riding together in the vehicle, alights, the utility calculation part 204A calculates the utility of each of the plurality of passengers based on the boarding point, the alighting point, the boarding time, and the alighting time of each passenger acquired by the passenger information acquisition part 203A.

Note that the calculation method of utility by the utility calculation part 204A is the same as the calculation method of utility by the utility calculation part 204 in the first embodiment. In the first embodiment, the utility is calculated based on the boarding time and the alighting time estimated from the boarding point and the alighting point, but in the second embodiment, the utility is calculated based on the boarding time and the alighting time having been acquired.

Upon receiving dispatch request information, the fare presentation image generation part 208A generates a scheduled fare presentation image for presenting, as a scheduled fare to be charged to each passenger, the fare of each passenger calculated by the fare calculation part 207. The fare presentation image generation part 208A generates a plurality of fixed fare presentation images for presenting the fare of each of the plurality of passengers calculated by the fare calculation part 207 to each of a plurality of passengers as a fixed fare to be charged to each passenger. When the last passenger, among the plurality of passengers riding together in the vehicle, alights, the fare presentation image generation part 208A generates a plurality of fixed fare presentation images.

The output part 209 transmits, via the communication part 23, a scheduled fare presentation image generated by the fare presentation image generation part 208A to the driver terminal 3 or the passenger terminal 1 of each passenger. The output part 209 transmits, via the communication part 23, the plurality of fixed fare presentation images generated by the fare presentation image generation part 208A to the driver terminal 3 operated by the driver who drives the vehicle or the plurality of passenger terminals 1 operated by each of the plurality of passengers.

The communication part 23 transmits, to the driver terminal 3 or the passenger terminal 1, a scheduled fare presentation image generated by the fare presentation image generation part 208A. The communication part 23 transmits the plurality of fixed fare presentation images generated by the fare presentation image generation part 208A to the driver terminal 3 or the plurality of passenger terminals 1.

Next, the fare calculation processing of the server 2A in the second embodiment of the present disclosure will be described.

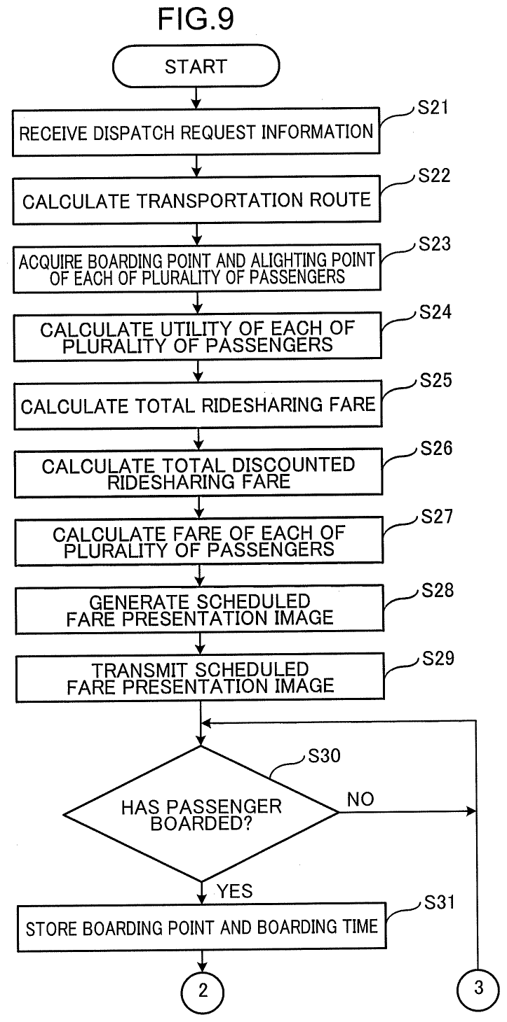

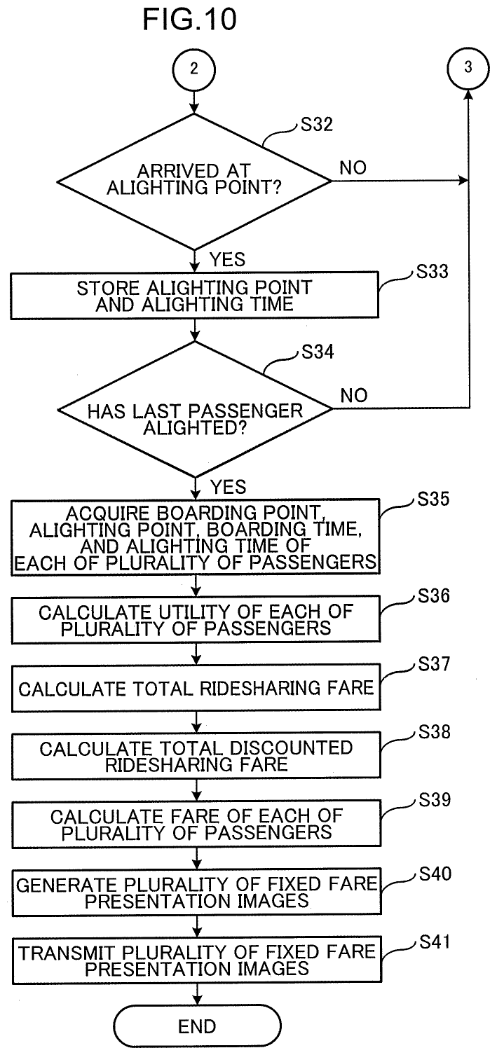

FIG. 9 is the first flowchart for explaining the fare calculation processing of the server 2A in the second embodiment of the present disclosure, and FIG. 10 is the second flowchart for explaining the fare calculation processing of the server 2A in the second embodiment of the present disclosure.

Since the processing of steps S21 to S27 is the same as the processing of steps S1 to S7 shown in FIG. 3, the description thereof will be omitted.

Next, in step S28, the fare presentation image generation part 208A generates a scheduled fare presentation image for presenting, as a scheduled fare to be charged to each passenger, the fare of each passenger calculated by the fare calculation part 207. The fare presentation image generation part 208A generates a scheduled fare presentation image of each of the plurality of passengers.

Next, in step S29, the output part 209 transmits, via the communication part 23, the scheduled fare presentation image generated by the fare presentation image generation part 208A to the driver terminal 3 or the passenger terminal 1 of each passenger. When the communication part 23 receives dispatch request information from the driver terminal 3, the output part 209 transmits the scheduled fare presentation image to the driver terminal 3. When the communication part 23 receives dispatch request information from the passenger terminal 1 of each passenger, the output part 209 transmits the scheduled fare presentation image to the passenger terminal 1 of each passenger.

The driver terminal 3 or the passenger terminal 1 of each passenger receives a scheduled fare presentation image transmitted by the server 2A, and displays the scheduled fare presentation image having been received.

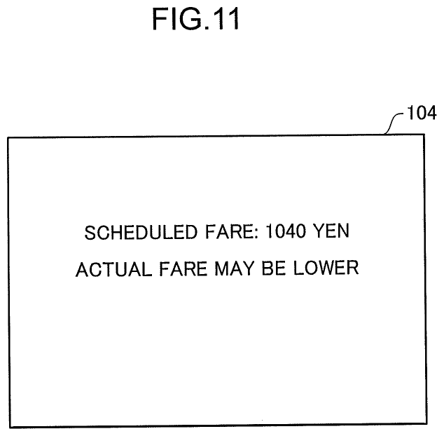

FIG. 11 is a view illustrating an example of a scheduled fare presentation image displayed on the passenger terminal 1 of each passenger in the second embodiment.

The scheduled fare presentation image 104 illustrated in FIG. 11 includes a fare scheduled to be paid by the passenger who uses the passenger terminal 1. The display part of the passenger terminal 1 displays the scheduled fare presentation image 104. By confirming the scheduled fare presentation image 104 displayed on the passenger terminal 1, the passenger can know the fare scheduled to be paid by the passenger himself/herself. As described above, in the second embodiment, the vehicle may allow a passenger who has not requested dispatch in advance to board. Therefore, the fare finally paid by the passenger may be different from the scheduled fare, and may be lower than the scheduled fare. Therefore, the scheduled fare presentation image 104 includes a sentence for notifying that the fare may actually be lower.

Note that when the display part of the driver terminal 3 displays the scheduled fare presentation image 104, the scheduled fare presentation image 104 may include the fare scheduled to be paid by each of the plurality of passengers. When a plurality of passengers board at the same time, the driver terminal 3 may collectively display the fare of each of the plurality of passengers.

Returning to FIG. 9, next, in step S30, the reservation processing part 201A determines whether or not the passenger has boarded. The reservation processing part 201A acquires, via communication part 23, the boarding information including the information for identifying the passenger, the boarding point, and the boarding time from the driver terminal 3. When receiving the boarding information, the reservation processing part 201A determines that the passenger has boarded.

Here, when it is determined that the passenger has not boarded (NO in step S30), the determination in step S30 is performed again.

On the other hand, when it is determined that the passenger has boarded (YES in step S30), in step S31, the reservation processing part 201A stores, in the passenger information storage part 221A in association with the passenger, the boarding point and the boarding time included in the boarding information received by communication part 23. Note that the reservation processing part 201A updates the boarding point already stored in the passenger information storage part 221A to the boarding point included in the boarding information. Due to this, a more accurate boarding point is stored in the passenger information storage part 221A.

Note that, in the second embodiment, the vehicle may allow a passenger who has not requested dispatch in advance to board. When the vehicle allows a passenger whose boarding point and alighting point are not stored in the passenger information storage part 221A to board, the driver terminal 3 may transmit, to the server 2, boarding information including information for identifying the passenger, the boarding point, the alighting point, and the boarding time. Then, when it is determined that the passenger has boarded, the reservation processing part 201A may determine whether or not the boarding point included in the boarding information received by the communication part 23 is stored in the passenger information storage part 221A. When it is determined that the boarding point is stored in the passenger information storage part 221A, the reservation processing part 201A may store, in the passenger information storage part 221A in association with the passenger, the boarding point and the boarding time included in the boarding information received by communication part 23. On the other hand, when it is determined that the boarding point is not stored in the passenger information storage part 221A, the reservation processing part 201A may store, in the passenger information storage part 221A in association with the passenger, the boarding point, the alighting point, and the boarding time included in the boarding information received by the communication part 23. Then, the transportation route calculation part 202 may calculate again a transportation route for transporting a plurality of passengers including a newly boarded passenger.

Next, in step S32, the fare presentation image generation part 208A determines whether or not the vehicle has arrived at the alighting point. The driver terminal 3 may receive an input by the driver as to whether or not the vehicle has arrived at the alighting point. When the vehicle arrives at the alighting point and the passenger alights, the driver touches an alighting button displayed on the driver terminal 3. When the alighting button is touched, the driver terminal 3 transmits alighting information to the server 2. The fare presentation image generation part 208A determines whether the vehicle has arrived at the alighting point based on whether or not the alighting information has been received. The alighting information includes information for identifying an alighting passenger, position information of an alighting point, and an alighting time. The communication part 23 of the server 2 receives the alighting information transmitted by the driver terminal 3. The fare presentation image generation part 208A recognizes which passenger, among the plurality of passengers, alights based on the information for identifying the passenger included in the alighting information.

Here, when it is determined that the vehicle has not arrived at the alighting point (NO in step S32), the determination in step S32 is performed again.

On the other hand, when it is determined that the vehicle has arrived at the alighting point (YES in step S32), in step S33, the reservation processing part 201A stores, in the passenger information storage part 221A in association with the passenger, the alighting point and the alighting time included in the alighting information received by communication part 23. Note that the reservation processing part 201A updates the alighting point already stored in the passenger information storage part 221A to the alighting point included in the alighting information. Due to this, a more accurate alighting point is stored in the passenger information storage part 221A.

Next, in step S34, the fare presentation image generation part 208 determines whether or not the last passenger, among the plurality of passengers riding together in the vehicle, has alighted. Here, when it is determined that the last passenger has not alighted (NO in step S34), the processing returns to step S30.

On the other hand, when it is determined that the last passenger has alighted from the vehicle (YES in step S34), in step S35, the passenger information acquisition part 203A acquires, from the passenger information storage part 221, the boarding point, the alighting point, the boarding time, and the alighting time of each of the plurality of passengers riding together in the vehicle.

Next, in step S36, the utility calculation part 204A calculates the utility indicating the satisfaction level of each of the plurality of passengers with the ridesharing service based on the boarding point, the alighting point, the boarding time, and the alighting time of each passenger. The utility calculation part 204A calculates the utility of each of the plurality of passengers based on the above Equation (2).

Next, in step S37, the total ridesharing fare calculation part 205 calculates a total ridesharing fare charged to an arbitrary passenger when the vehicle transports the arbitrary passenger through the route from the point where the first passenger, among the plurality of passengers, is picked up to the point where the last passenger is dropped off.

Next, in step S38, the total discounted ridesharing fare calculation part 206 reads the discount coefficient from the discount coefficient storage part 222, and calculates the total discounted ridesharing fare in which the total ridesharing fare calculated by the total ridesharing fare calculation part 205 is multiplied by the discount coefficient.

Next, in step S39, the fare calculation part 207 calculates, as a fare of each of the plurality of passengers, an amount obtained by distributing the total discounted ridesharing fare to the plurality of passengers in accordance with a ratio of the utility of each of the plurality of passengers.

Next, in step S40, the fare presentation image generation part 208A generates a plurality of fixed fare presentation images for presenting the fare of each passenger calculated by the fare calculation part 207 to each of a plurality of passengers as a fixed fare to be charged to each passenger. The fare presentation image generation part 208A generates a fixed fare presentation image of each of the plurality of passengers.

Next, in step S41, the output part 209 transmits, via the communication part 23, each of the plurality of fixed fare presentation images generated by the fare presentation image generation part 208A to the passenger terminal 1 of each of the plurality of passengers.

The passenger terminal 1 of each passenger receives the fixed fare presentation image transmitted by the server 2, and displays the fixed fare presentation image having been received.

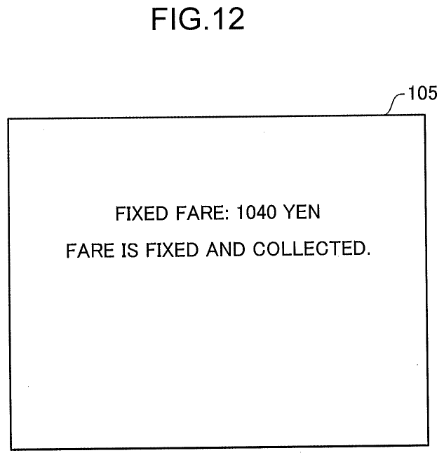

FIG. 12 is a view illustrating an example of a fixed fare presentation image displayed on the passenger terminal 1 of a passenger who has already alighted in the second embodiment.

A fixed fare presentation image 105 illustrated in FIG. 12 includes a fixed fare to be paid by the passenger who uses the passenger terminal 1. The display part of the passenger terminal 1 displays the fixed fare presentation image 105. By confirming the fixed fare presentation image 105 displayed on the passenger terminal 1, the passenger can know the fare to be paid by the passenger himself/herself. At a time point when the last passenger, among the plurality of passengers who ride together, alights and the fare is fixed, the fare of each passenger is withdrawn from the bank account of each passenger. Therefore, the fixed fare presentation image 105 includes a sentence for notifying that the fare is fixed and collected.

In this manner, when the last passenger, among the plurality of passengers, alights, the fare of each of the plurality of passengers is calculated, and the fare of each of the plurality of passengers having been calculated is presented to each of the plurality of passengers as the fixed fare to be charged to each passenger. Therefore, a more accurate fare can be charged.

The vehicle can also pick up another unreserved passenger during transportation of the passenger. In this case, there is a possibility that a section in which passengers do not ride together occurs in one transportation. For example, consider a case where the first passenger and the second passenger board at the first point, the second passenger alights at the second point, the third passenger boards at the third point, the first passenger alights at the fourth point, and the third passenger alights at a fifth point. In this case, the first passenger rides together with the second passenger and the third passenger, but the second passenger does not ride together with the third passenger. In the second embodiment, the fare of each of the plurality of passengers is calculated when the last passenger, among the plurality of passengers, alights from the vehicle, and therefore, even if a section in which passengers do not ride together occurs, the fare can be fairly charged to the plurality of passengers.

Note that in the first and second embodiments, the discount coefficient is a predetermined fixed value, but the present disclosure is not particularly limited to this. The discount coefficient may be determined such that transporting a plurality of passengers together is more beneficial to the transport operator (or the driver) than transporting passengers individually.

In this case, the discount coefficient calculation part is further implemented by the processors 21 and 21A. The discount coefficient calculation part calculates an individual fare to be charged to each of a plurality of passengers when each of the plurality of passengers is transported individually. Then, the discount coefficient calculation part calculates an expected fare in which a highest individual fare among a plurality of individual fares having been calculated is multiplied by a predetermined coefficient a (a is a real number larger than 1). The predetermined coefficient a is preset by the transport operator (or the driver). The expected fare is a fare obtained by the transport operator (or the driver), and is set to be higher than the highest individual fare. The discount coefficient calculation part calculates the discount coefficient by dividing the calculated expected fare by the total ridesharing fare.

For example, when the individual fare of the first passenger is 1200 yen, the individual fare of the second passenger is 1400 yen, the individual fare of the third passenger is 1600 yen, the individual fare of the fourth passenger is 1800 yen, the total ridesharing fare is 2500 yen, and the coefficient a is 1.1, the expected fare is 1980 yen (=1800 yen×1.1), and the discount coefficient is 0.792 (=expected fare/total ridesharing fare=1980 yen/2500 yen).

The discount coefficient may also be determined so that the passenger does not lose money.

In this case, the discount coefficient calculation part is further implemented by the processors 21 and 21A. The discount coefficient calculation part calculates an individual fare to be charged to each of a plurality of passengers when each of the plurality of passengers is transported individually. Then, the discount coefficient calculation part calculates an expected fare in which a sum of a plurality of individual fare having been calculated is multiplied by a predetermined coefficient b (b is a real number larger than 0 and equal to or smaller than 1). The predetermined coefficient b is preset by the transport operator (or the driver). The discount coefficient calculation part calculates the discount coefficient by dividing the calculated expected fare by the total ridesharing fare.

For example, when the individual fare of the first passenger is 1200 yen, the individual fare of the second passenger is 1400 yen, the individual fare of the third passenger is 1600 yen, the individual fare of the fourth passenger is 1800 yen, the total ridesharing fare is 2500 yen, and the coefficient b is 0.5, the expected fare is 3000 yen (=(1200 yen+1400 yen+1600 yen+1800 yen)×0.5), and the discount coefficient is 1.2 (=expected fare/total ridesharing fare=3000 yen/2500 yen).

Note that in each of the above embodiments, each constituent element may be implemented by being configured with dedicated hardware or by execution of a software program suitable for each constituent element. Each constituent element may be implemented by a program execution unit, such as a CPU or a processor, reading and executing a software program recorded in a recording medium such as a hard disk or a semiconductor memory. The program may be carried out by another independent computer system by being recorded in a recording medium and transferred or by being transferred via a network.

Some or all functions of the device according to the embodiments of the present disclosure are implemented as large scale integration (LSI), which is typically an integrated circuit. These functions may be individually integrated into one chip, or may be integrated into one chip so as to include some or all functions. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the device according to the embodiments of the present disclosure may be implemented by a processor such as a CPU executing a program.

All numbers used above are illustrated to specifically describe the present disclosure, and the present disclosure is not limited to the illustrated numbers.

The order in which steps shown in the above flowcharts are executed is for specifically describing the present disclosure, and may be any order other than the above order as long as a similar effect is obtained. Some of the above steps may be executed simultaneously (in parallel) with other steps.

Since the technique according to the present disclosure can fairly charge a fare to each of a plurality of passengers who ride together, the technique is useful as a technique for calculating a fare to be charged to a plurality of passengers riding together in a vehicle.

1. An information processing method by a computer, the method comprising:
acquiring a boarding point and an alighting point of each of a plurality of passengers riding together in a vehicle;
calculating utility enjoyed by each of the plurality of passengers for a ridesharing service based on the boarding point and the alighting point of each passenger;
calculating a total ridesharing fare for transportation through a route from a point where a first passenger, among the plurality of passengers, is picked up to a point where a last passenger is dropped off; and
calculating, as a fare to be charged to each passenger, an amount obtained by distributing the total ridesharing fare to the plurality of passengers in accordance with a ratio of the utility of each of the plurality of passengers.

2. The information processing method according to claim 1, wherein the utility indicates a satisfaction level of each of the plurality of passengers with the ridesharing service.

3. The information processing method according to claim 2, wherein the utility is a value that increases as a time for riding together with another passenger decreases, and that decreases as the time for riding together with another passenger increases.

4. The information processing method according to claim 2, wherein the utility is calculated based on individual utility obtained by any of a fare to be charged to a passenger when the passenger is transported individually, a travel distance by which the vehicle travels when the passenger is transported individually, and a travel time required for the vehicle to travel when the passenger is transported individually, and a burden share for ridesharing obtained by a riding time in which the passenger is on board on a route from a point where a first passenger, among the plurality of passengers, is picked up to a point where a last passenger is dropped off.

5. The information processing method according to claim 2, wherein the utility is calculated based on individual utility obtained by any of a fare to be charged to a passenger when the passenger is transported individually, a travel distance by which the vehicle travels when the passenger is transported individually, and a travel time required for the vehicle to travel when the passenger is transported individually, and a burden share for ridesharing obtained by a number of other passengers with whom the passenger rides together and a riding time in accordance with the number of other passengers on a route from a point where a first passenger, among the plurality of passengers, is picked up to a point where a last passenger is dropped off.

6. The information processing method according to claim 4, wherein
the utility is calculated for each of the plurality of passengers based on following Equation (1):
Utility=individual utility−α*burden share for ridesharing (1)
where the α is a predetermined coefficient.

7. The information processing method according to claim 1 further comprising multiplying the total ridesharing fare by a discount coefficient,
wherein calculating the fare includes calculating, as a fare to be charged to each passenger, an amount obtained by distributing the total ridesharing fare multiplied by the discount coefficient to the plurality of passengers in accordance with a ratio of the utility of each of the plurality of passengers.

8. The information processing method according to claim 7, wherein the discount coefficient is stored in advance.

9. The information processing method according to claim 7 further comprising:
calculating an individual fare to be charged to each of the plurality of passengers when each of the plurality of passengers is transported individually;
calculating an expected fare in which a highest individual fare among a plurality of individual fares having been calculated is multiplied by a predetermined coefficient a (a is a real number larger than 1); and
calculating the discount coefficient by dividing, by the total ridesharing fare, the expected fare having been calculated.

10. The information processing method according to claim 7 further comprising:
calculating an individual fare to be charged to each of the plurality of passengers when each of the plurality of passengers is transported individually;
calculating an expected fare in which a sum of a plurality of individual fare having been calculated is multiplied by a predetermined coefficient b (b is a real number larger than 0 and equal to or smaller than 1); and
calculating the discount coefficient by dividing, by the total ridesharing fare, the expected fare having been calculated.

11. The information processing method according to claim 1 further comprising:
generating a fare presentation image for presenting the fare having been calculated; and
outputting the fare presentation image having been generated.

12. The information processing method according to claim 11 further comprising receiving dispatch request information including the boarding point and the alighting point transmitted by a driver terminal operated by a driver who drives the vehicle or a passenger terminal operated by each of the plurality of passengers, wherein
generating the fare presentation image includes, upon receiving the dispatch request information, generating a scheduled fare presentation image for presenting, as a scheduled fare to be charged to each passenger, the fare having been calculated, and
outputting the fare presentation image includes transmitting the scheduled fare presentation image having been generated to the driver terminal or the passenger terminal.

13. The information processing method according to claim 11 wherein
generating the fare presentation image includes generating a fixed fare presentation image for presenting the fare having been calculated to one passenger who alights among the plurality of passengers as a fixed fare to be charged to the one passenger when the one passenger alights, and
outputting the fare presentation image includes transmitting the fixed fare presentation image having been generated to a driver terminal operated by a driver who drives the vehicle or a passenger terminal operated by the one passenger.

14. The information processing method according to claim 11 further comprising determining whether or not a last passenger, among the plurality of passengers, has alighted, wherein
acquiring the boarding point and the alighting point includes acquiring the boarding point, the alighting point, a boarding time, and an alighting time of each of the plurality of passengers when determining that the last passenger has alighted,
calculating the utility includes calculating the utility of each of the plurality of passengers based on the boarding point, the alighting point, the boarding time, and the alighting time of each passenger,
generating the fare presentation image includes generating a plurality of fixed fare presentation images for presenting the fare of each of the plurality of passengers having been calculated to each of the plurality of passengers as a fixed fare to be charged to each passenger, and
outputting the fare presentation image includes transmitting the plurality of fixed fare presentation images having been generated to a driver terminal operated by a driver who drives the vehicle or a plurality of passenger terminals operated by each of the plurality of passengers.

15. An information processing device comprising:
an acquisition part that acquires a boarding point and an alighting point of each of a plurality of passengers riding together in a vehicle;
a utility calculation part that calculates utility enjoyed by each of the plurality of passengers for a ridesharing service based on the boarding point and the alighting point of each passenger;
a total ridesharing fare calculation part that calculates a total ridesharing fare for transportation through a route from a point where a first passenger, among the plurality of passengers, is picked up to a point where a last passenger is dropped off; and
a fare calculation part that calculates, as a fare to be charged to each passenger, an amount obtained by distributing the total ridesharing fare to the plurality of passengers in accordance with a ratio of the utility of each of the plurality of passengers.

16. A non-transitory computer readable recording medium storing an information processing program that causes a computer to function to:
acquire a boarding point and an alighting point of each of a plurality of passengers riding together in a vehicle;
calculate utility enjoyed by each of the plurality of passengers for a ridesharing service based on the boarding point and the alighting point of each passenger;
calculate a total ridesharing fare for transportation through a route from a point where a first passenger, among the plurality of passengers, is picked up to a point where a last passenger is dropped off; and
calculate, as a fare to be charged to each passenger, an amount obtained by distributing the total ridesharing fare to the plurality of passengers in accordance with a ratio of the utility of each of the plurality of passengers.
